(19) United States
(12) Patent Application Publication
(10) Pub. No.: US 2018/0230937 A1
(43) Pub. Date: Aug. 16, 2018

(54) Method for Producing a Monoblock Piston, and Monoblock Piston

(71) Applicant: KS Kolbenschmidt GmbH, Neckarsulm (DE)

(72) Inventor: Matthias Laqua, Bad Wimpfen (DE)

(21) Appl. No.: 15/751,277

(22) PCT Filed: Aug. 11, 2016
(86) PCT No.: PCT/EP2016/069172

§ 371 Date: Feb. 8, 2018

(30) Foreign Application Priority Data
Aug. 11, 2015 (DE) 10 2015 215 312.6

(51) Int. Cl. F02F 3/20; B21K 1/18

(52) U.S. Cl. CPC F02F 3/20; F02F 2003/0007; F02F 2200/04; B21K 1/185

(57) ABSTRACT

Disclosed is a monoblock or cooling channel piston and a method for producing a monoblock piston for use in an internal combustion engine. A piston blank includes a circumferential collar protruding radially in the region of the piston crown is first produced and the collar is then shaped. A contact region on a top region of the piston skirts and the collar is shaped such that the outer circumferential edge thereof points at a distance to the contact region and forms a defined gap. The gap is then sealed by a closure element in order to form a closed cooling channel.

### TECHNICAL FIELD

The invention relates to a monoblock piston for internal combustion engines and to a method for producing it in accordance with the features of the respective preamble of the independent claims.

### BACKGROUND

It is fundamentally known to produce blanks for pistons using the casting or forging method, which pistons have, inter alia, a cooling duct after their final machining. Combinations of the two above-mentioned methods are also conceivable here. The forging method may be suitable, since a piston which is produced using the forging method has improved strength properties over a piston which has been produced using the casting method. In the case of piston blanks which are produced using the forging method, a complicated process is required, in order to introduce a cooling duct which lies in the ring zone region into said piston blank. In comparison with cast piston blanks, lost cores cannot be used in the case of blanks which are produced using the forging method. It has therefore always been problematic to introduce the cooling duct by way of suitable steps. For this purpose, it is known that a recess is introduced in a radially circumferential manner by way of machining with the removal of material, and is closed by way of suitable means. Here, however, attention is to be paid to the dimensional accuracy of the recess and the means which are to close said recess, as a result of which an expensive work step becomes additionally necessary. The elements which are involved can be manufactured only with corresponding complexity as a result of the required dimensional accuracy.

DE 10 2004 031 513 A1 discloses a method for producing a cooling duct piston for an internal combustion engine, which cooling duct piston has a cooling duct in its piston crown, the piston crown being adjoined by a piston lower part with piston bosses, pin bores and piston skirts, a piston blank having a circumferential collar which projects radially in the region of the piston crown first of all being produced, the collar subsequently being shaped, it being provided that a bearing region for the collar is formed in a transition region between the piston crown and the piston lower part, and the collar being reshaped in such a way until its outer radially circumferential edge comes very close to or completely in contact with the bearing region, in order to form a closed cooling duct. It is important to close the cooling duct virtually completely or even completely (apart from at least in each case one feed opening and discharge opening), in order that no cooling medium which circulates in the cooling duct during the operation of the piston is lost, but rather is available for the dissipation of heat. In order to close the cooling duct completely in the case of said known piston, the circumferential free edge of the reshaped collar has to come into positively locking connection with the bearing region above the piston skirts. This is very difficult to bring about using the forging or forming method. Said prior art therefore also provides that the circumferential free edge of the reshaped collar is joined in an integrally joined manner to the bearing region above the piston skirts, for example by way of welding. However, on account of deformations of the piston crown during the operation in the cylinder of the internal combustion engine, there is the risk of crack formations in the joint region, which results in further disadvantages (in particular, propagation of the crack into the piston main body).

DE 10 2008 055 848 A1 relates to a cooling duct piston which has a radially circumferential cooling duct which lies behind a ring zone, the cooling duct piston being forged from a steel material, and the cooling duct being made by way of machining with the removal of material between an upper part below the ring zone and a lower part above piston bosses and piston skirts, the cooling duct extending behind the ring zone in the direction of an upper side of the upper part, the cooling duct piston having an outwardly pointing supporting region above its piston bosses and piston skirts, a closure element being arranged and fastened between the lower edge of the ring zone and the supporting region, which closure element closes the cooling duct after its production.

There are great restrictions with regard to the structural boundary parameters in the case of the construction according to DE 10 2008 055 848 A1. This applies, in particular, to the introduction of the circumferential downwardly open groove which forms the cooling duct after being covered. The height of the finished cooling duct is restricted to a very great extent by way of the tool for cutting the groove, and is insufficient for a volume which is required for cooling purposes.

### SUMMARY

The invention is therefore based on the object of providing a monoblock piston without any structural restrictions, and of providing a method for producing it.

With regard to the method according to the invention for producing a cooling duct piston, it is provided according to the invention that a bearing region is provided on an upper region of the piston skirts, and the collar is reshaped in such a way that its outer circumferential edge points toward the bearing region at a spacing and forms a defined gap, the gap subsequently being closed by way of a closure element, in order to form a closed cooling duct.

In the case of said method, the reshaping of the collar from an angled-away position in relation to the piston stroke axis into a parallel position in relation to the piston stroke axis is maintained, in order to form a downwardly open cavity which forms the subsequent cooling duct of the piston behind the circumferential collar after it is reshaped. At the same time, the piston blank is provided with a bearing region in its upper region of the piston skirts, the bearing region being positioned in such a way and the collar being reshaped in such a way that a defined gap is produced between the outer circumferential downwardly pointing end side of the reshaped collar and the surface of the bearing region.

It can be intended that, in order to improve the defined gap which results from the reshaping operation, the outer circumferential edge of the reshaped collar and/or the bearing region are/is dimensioned correctly by way of machining, preferably by way of machining with the removal of material.

In order to close the subsequent cooling duct, a closure element is inserted circumferentially into said gap. Although it is not ruled out in principle to configure said closure element in one piece, it is advantageously configured in two or more pieces in one development of the invention. The closure element is preferably formed from two identical half shells.

The single-piece closure element, but also likewise the two-piece or multiple-piece closure element, can in principle be connected permanently to the piston blank. This takes place, by way of example, by way of clipping, pressing, adhesive bonding, welding, brazing or the like. In this way, there is the advantage that the upper part of the piston can be supported on the lower part, in particular the piston skirts, on account of its deformations during the operation in the cylinder of the internal combustion engine. If the closure element is configured in two or more pieces, it is conceivable to fasten it to the piston main body (piston blank) not only in a positively locking and/or integrally joined manner, but rather also to connect its abutting ends to one another in a positively locking and/or integrally joined manner in the process (only part of the abutting ends or all of them), or to not connect its abutting ends to one another, but rather to bring them to bear against one another in an abutting manner or to leave a gap between them (if the two-piece or multiple-piece closure element is situated in its intended position in the defined gap).

In practice, however, it has been proven surprisingly that stresses and, as a consequence, cracks occur on account of the deformations of the piston upper part (piston crown) during the operation of the piston in the internal combustion engine, in particular in the region of welded or brazed connections between the piston main body and the closure element. In order to counteract said disadvantage, it is provided in a particularly advantageous way that the closure element is configured in two or more pieces (preferably two identical half shells) and its abutting ends are connected to one another (in order to realize a continuous annular closure element), the closure element not being connected in an integrally joined manner to the piston blank after said connection. As a result, no stresses can be transmitted to the closure element, and no integrally joined connections, such as welded or brazed connections, are required from the closure element to the piston main body, in order to also avoid cracks in the region of said connections.

It is provided in one development of the invention that boundaries for the contact of the closure element are provided on the bearing region (that is to say, above the piston skirts) and/or the outer circumferential edge of the collar, in particular when the closure element is not connected in an integrally joined manner to the piston blank. This advantageously ensures not only that there are no integrally joined connections between the closure element and the piston main body, but rather also that the closure element remains in its setpoint position during the operation of the piston in the internal combustion engine, after its abutting ends have been joined together.

The same abovementioned refinements and advantages which result from them with regard to the method for producing a cooling duct piston apply in the same way to the cooling duct piston itself.

One exemplary embodiment of the method according to the invention for producing a cooling duct piston, to which exemplary embodiment, however, the present invention is not restricted, is described in the following text and explained using the figures.

### BRIEF DESCRIPTION OF THE DRAWINGS

FIGS. 1 to 4 show the individual steps of the method according to the invention for producing the cooling duct piston.

FIG. 5 shows a detailed view of a closure element which is inserted into a gap.

### DETAILED DESCRIPTION

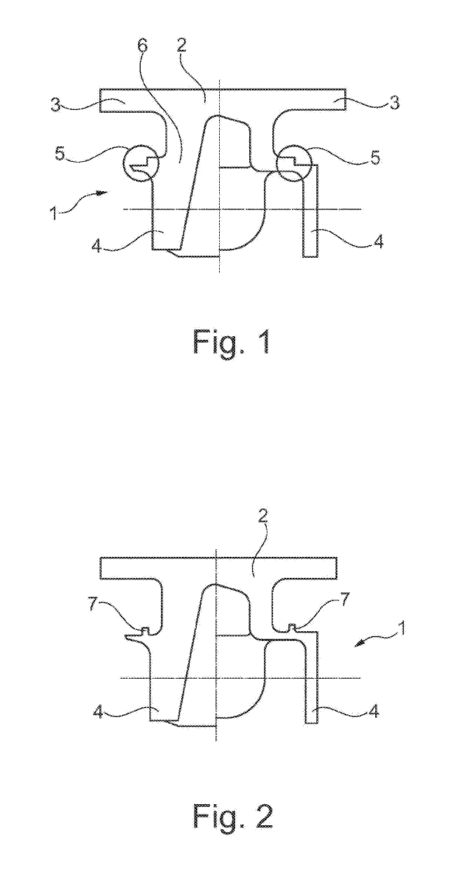

Referring to FIG. 1, the designation 1 shows a piston blank which is produced, for example, using a casting or forging method. These can also be other production methods for a piston blank, such as the extrusion method. The method, by way of which the piston blank 1 is produced, is as a rule based on the design of the piston and the strength requirements made of the piston. The piston blank 1 which is shown in FIG. 1 has a piston crown 2 (upper part), a collar 3 projecting from the piston crown 2 in a radially circumferential manner. Piston bosses 4 with piston skirts and pin bores and possibly further elements which together form a piston lower part are situated on the piston crown 2 toward the bottom.

There is a bearing region 5 (with an indicated step or else without one) in a transition region between the piston crown 2 and the piston lower part, preferably on the lower circumferential edge of the piston bosses 4, which bearing region 5 (as has already been illustrated) is situated in a transition region 6 between the piston crown 2 and the piston lower part. Said transition region 6 is configured approximately as a circumferential land in the case of the piston blank 1 according to FIG. 1, but can also have different geometries in the case of other piston designs. The bearing region 5 serves to form a gap after it has been reshaped. A closure element is inserted subsequently into said gap (see FIGS. 3 and 4). In order for it to be possible to define the setpoint position of the closure element in an improved manner, there is/are a radially circumferential land 7 or part regions of a land in the bearing region 5 according to FIG. 2, it being possible for the land 7 to be produced, for example, by way of machining with the removal of material. This embodiment is shown in FIG. 2, it also being possible for there to be a simple step in the bearing region 5, with which step the closure element can come into contact when it is inserted into the gap.

FIG. 3 shows the collar 3 after being reshaped. It can be seen that the outer radially circumferential part of the collar 3 is angled away by approximately 90°. A radially circumferential cooling duct 8 and a defined gap 9 are formed by way of said reshaping and the corresponding forming of the piston crown 2 with the projecting collar 3 which is present there, it being of particular significance that the inner wall of the transition region 6 merges into the collar 3 in a rounded manner, in order to ensure the subsequent cross-sectional shape of the cooling duct 8.

After the piston blank 1 has been produced according to FIG. 3, it can be subjected to final machining, with the result that, after said final machining, the finished cooling duct piston with closure element 10 which is inserted in the gap 9 is available, which finished cooling duct piston or monoblock piston 11 is provided with the designation 11 in FIG. 4. In the case of said design of the cooling duct piston 11 which is shown in the exemplary embodiment, a combustion chamber recess 12 is also made in the piston crown 2. Ring grooves of a ring zone 13 are made in the region of the piston crown 2 and therefore also at least partially in the region of the reshaped collar 3. In the case of said finished cooling duct piston 11, a pin bore is provided with the designation 14 and a piston skirt is provided with the designation 15. At least one opening 16 (bore) is likewise provided for the exchange of cooling medium into the cooling duct 8 and out of it again, which opening 16 has been made parallel to the piston stroke axis 17 in the direction of the cooling duct 8.

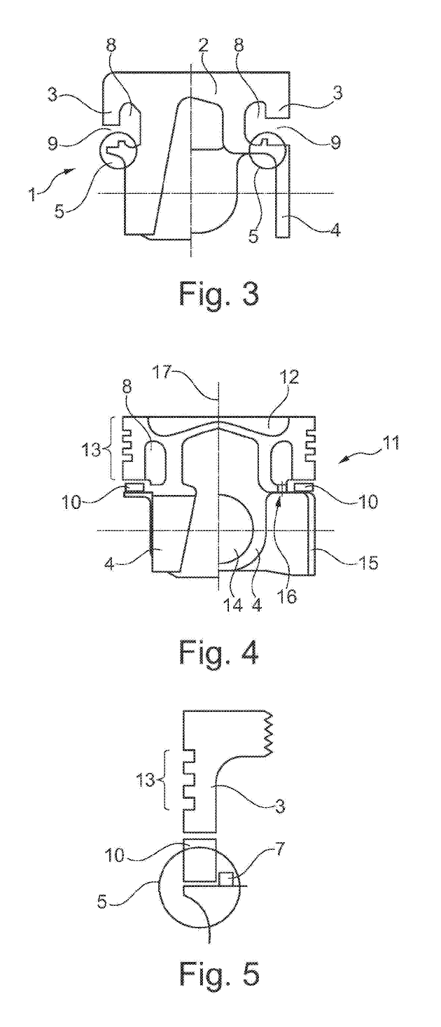

FIG. 5 shows details of the finished one-piece cooling duct piston 11, in which the two-piece or multiple-piece closure element 10 has been inserted into the gap 9. Said closure element 10 is joined together merely at its abutting ends, but is not connected in an integrally joined manner to the piston blank 1 (piston main body). It is therefore, in particular, not welded to the piston blank 1. The gap 9 is closed completely at the top and bottom (in the case of the view of FIG. 4) by way of the closure element 10, or a residual gap can remain, as can be seen clearly in FIG. 4. The land 7 serves to limit the position of the closure element 10. After the closure element 10 has been inserted into the gap 9 and its abutting ends have been joined together, final machining of the cooling duct piston 11 can take place only subsequent to or in addition to a preceding machining operation of the piston blank 1.

Finally, it is also to be noted that the piston blank 1 or the cooling duct piston 11 is shown in FIGS. 1 to 4 along the piston stroke axis 17 in two different views (in one case on the left and in one case on the right of the piston stroke axis 17).

1. A method for producing a cooling duct piston for an internal combustion engine, which cooling duct piston has a cooling duct in its piston crown, the piston crown being adjoined by a piston lower part with piston bosses, pin bores and piston skirts, a piston blank having a circumferential collar which projects radially in the region of the piston crown first of all being produced, and the collar subsequently being reshaped, characterized in that a bearing region is provided on an upper region of the piston skirts, and the collar is reshaped in such a way that the outer circumferential edge points toward the bearing region at a spacing defining a gap, the gap subsequently being closed by way of a closure element, in order to form a closed cooling duct.

2. The method as claimed in claim 1, characterized in that the piston blank is produced using a forging method.

3. The method as claimed in claim 1 wherein the closure element comprises two or more pieces each having ends, the method further comprising arranging the two or more closure element pieces ends in abutting engagement with one another at a setpoint position in the gap; and connecting the abuttingly engaged ends of the two or more closure elements.

4. The method as claimed in claim 1, characterized in that the closure element is not connected in an integrally joined manner to the piston blank.

5. The method as claimed in claim 1, characterized in that boundaries for a contact of the closure element are provided on one of the bearing region or the outer circumferential edge of the collar.

6. A cooling duct piston for an internal combustion engine, which cooling duct piston has a cooling duct in its piston crown, the piston crown being adjoined by a piston lower part with piston bosses, pin bores and piston skirts, a piston blank having a circumferential collar which projects radially in the region of the piston crown first of all being produced, and the collar subsequently being reshaped, characterized in that a bearing region is provided on an upper region of the piston skirts, and the collar is reshaped in such a way that a outer circumferential edge points toward the bearing region at a spacing defining a gap, the gap being closed by way of a closure element operable to form a closed cooling duct.

7. The cooling duct piston as claimed in claim 6, characterized in that the closure element comprises two or more pieces each having abutting ends, the abutting ends are connected to one another after the two or more pieces are positioned at a setpoint position in the defined gap.

8. The cooling duct piston as claimed in claim 6, characterized in that the closure element is not connected in an integrally joined manner to the piston blank.

9. The cooling duct piston as claimed in claim 6, characterized in that boundaries for a contact of the closure element are positioned on one of the bearing region or the outer circumferential edge of the collar.
